(19) United States
(12) Patent Application Publication
(10) Pub. No.: US 2019/0241595 A1
(43) Pub. Date: Aug. 8, 2019

(54) ULTRAPURE KRAFT LIGNIN COMPOSITION

(71) Applicant: REN FUEL K2B AB, Stockholm (SE)

(72) Inventors: Christian DAHLSTRAND, Uppsala (SE); Alexander OREBOM, Uppsala (SE)

(21) Appl. No.: 16/312,254

(22) PCT Filed: Jun. 30, 2017
(86) PCT No.: PCT/SE2017/050735

§ 371 Date: Dec. 20, 2018

(30) Foreign Application Priority Data
Jul. 1, 2016 (SE) 1650964-8

(51) Int. Cl. C07G 1/00; C10G 3/00; C10L 1/04; C08L 97/00

(52) U.S. Cl. CPC C07G 1/00; C10G 3/42; C10L 1/04; C08L 97/005; C10L 2200/0469; C10L 2270/026; C10G 2300/1014; C10G 2300/202; C10G 2300/205; C10G 2400/04; C10G 2300/1003

(57) ABSTRACT

The present invention relates to a composition comprising Kraft lignin a very low amount of metal and inorganic compounds. The composition may be used in a refinery process to prepare fuel.

### FIELD OF THE INVENTION

The present invention relates to ultrapure Kraft lignin, a method of preparing said Kraft lignin and the use of the same.

### BACKGROUND

There is an increasing interest in using biomass as a source for fuel production and other various applications. Biomass includes, but is not limited to, plant parts, fruits, vegetables, processing waste, wood chips, chaff, grain, grasses, corn, corn husks, weeds, aquatic plants, hay, paper, paper products, recycled paper and paper products, lignocellulosic material, lignin and any cellulose containing biological material or material of biological origin.

An important component of biomass is the lignin present in the solid portions of the biomass. Lignin comprises chains of aromatic and oxygenated constituents forming larger molecules that are not easily treated. A major reason for difficulty in treating the lignin is the inability to disperse the lignin for contact with catalysts that can break the lignin down.

Lignin is one of the most abundant natural polymers on earth. One common way of preparing lignin is by separation from wood during pulping processes. Only a small amount (1-2%) is utilized in specialty products whereas the rest primary serves as fuel. Even if burning lignin is a valuable way to reduce usage of fossil fuel, lignin has significant potential as raw material for the sustainable production of chemicals and liquid fuels.

Various lignins differ structurally depending on raw material source and subsequent processing, but one common feature is a backbone consisting of various substituted phenyl propane units that are bound to each other via aryl ether or carbon-carbon linkages. They are typically substituted with methoxyl groups and the phenolic and aliphatic hydroxyl groups provide sites for e.g. further functionalization. Lignin is known to have a low ability to sorb water compared to for example the hydrophilic cellulose.

Today lignin may be used as a component in for example pellet fuel as a binder but it may also be used as an energy source due to its high energy content. Lignin has higher energy content than cellulose or hemicelluloses and one gram of lignin has on average 22.7 KJ, which is 30% more than the energy content of cellulosic carbohydrate. The energy content of lignin is similar to that of coal. Today, due to its fuel value lignin that has been removed using the kraft process, sulphate process, in a pulp or paper mill, is usually burned in order to provide energy to run the production process and to recover the chemicals from the cooking liquor.

There are several ways of separating lignin from black or red liquor obtained after separating the cellulose fibres in the kraft or sulphite process respectively, during the production processes. One of the most common strategies is membrane or ultra-filtration. Lignoboost® is a separation process developed by Innventia AB and the process has been shown to increase the lignin yield using less sulphuric acid. In the Lignoboost® process, black liquor from the production processes is taken and the lignin is precipitated through the addition and reaction with acid, usually carbon dioxide (CO₂), and the lignin is then filtered off. The lignin filter cake is then re-dispersed and acidified, usually using sulphuric acid, and the obtained slurry is then filtered and washed using displacement washing. The lignin is usually then dried and pulverized in order to make it suitable for lime kiln burners or before pelletizing it into pellet fuel.

The most common source for lignin today is from spent cooking liquor such as black or red liquor but lignin may also be obtained from the organosolv technique for example. The advantage of using cooking liquor as the lignin source is the availability and thereby the cost. All paper mills produce cooking liquor and besides the recycling of the cooking chemicals the liquor is more or less a by-product which is burnt. A problem with using cooking liquor as the source is that the lignin will contain a high amount of metals and other unwanted substances that mostly originates from cooking chemicals of the pulping process. Lignin obtained from organosolv does not have this problem but the organosolv technique itself is expensive.

Klett et al. (Chem. Commun., 2015, 51, 12855 and corresponding US20160137680) teaches as method of treating Kraft lignin with acetic acid at elevated temperature in several steps to obtain a lignin phase with a low sodium content. However the method is limited to prepare low sodium content lignin phase for high molecular weight lignin (MW>10,000 Da number average molecular weight) which is only 30 wt % of the total lignin content of the feed. Also Klett et al. is silent about the total metal content of the obtained lignin phases.

Many applications where lignin may be a suitable component more or less demands that the lignin does not have a high metal content. For example many catalysts, such as catalysts used in oil refineries, are poisoned by metals which means that if Kraft lignin were to be treated in a refinery for example the catalysts will be deactivated with time. There is therefore a need for a highly pure Kraft lignin.

### SUMMARY OF THE INVENTION

The object of the present invention is to overcome the drawbacks of the prior art. The present invention enables to use Kraft lignin in various refinery processes such as hydrotreatment, hydro cracking or slurry cracking. Additionally the high purity of the present lignin makes the lignin suitable for preparing composites.

In a first aspect the present invention relates to a composition comprising Kraft lignin having a weight average molecular weight (M_{w}) of less than 5,000 g/mol and wherein the total metal content of the composition is less than 400 ppm by weight; wherein the sodium content is less than 100 ppm by weight and wherein the content of transition metals is less than 150 ppm by weight.

In a second aspect the present invention relates to a method of preparing the aqueous composition according to the present invention comprising:
a. Providing an aqueous mixture of Kraft lignin;
b. Adding an aqueous solution of acid to the mixture of Kraft lignin wherein the acid has a pKa lower than 4.75, preferably lower than 3.5;
c. Letting the Kraft lignin precipitate;
d. Isolating at least a part of the precipitated lignin; and
e. Adding an aqueous solution to the isolated lignin in order to wash the lignin;
f. Isolating the washed lignin; and
g. Repeating step e and f at least once.

In a third aspect the present invention relates to the use of the composition according to the present invention for preparing fuel.

In a fourth aspect the present invention relates to the use of the composition according to the present invention in a hydrotreater and/or a catalytic cracker or a slurry cracker.

In a fifth aspect the present invention relates to a fuel obtained from the composition according to the present invention by treating the composition in a hydrotreater and/or a catalytic cracker or a slurry cracker.

In a sixth aspect the present invention relates to a composite comprising the lignin composition according to the present invention and a second polymer, wherein the second polymer may be selected from polyolefin, polyester, polyamide, polynitrile or a polycarbonate.

All the embodiments disclosed herein relates to all the aspects of the present invention.

### BRIEF DESCRIPTION OF THE FIGURES

FIG. 1 discloses a schematic picture of lignin.

FIG. 2 discloses the metal contents of various lignin types.

FIG. 3 discloses the sodium content for different acids.

### DETAILED DESCRIPTION OF THE INVENTION

The present invention relates to Kraft lignin which has a very high degree of purity and which may be used in a refinery processes for the production of various fuels or chemicals.

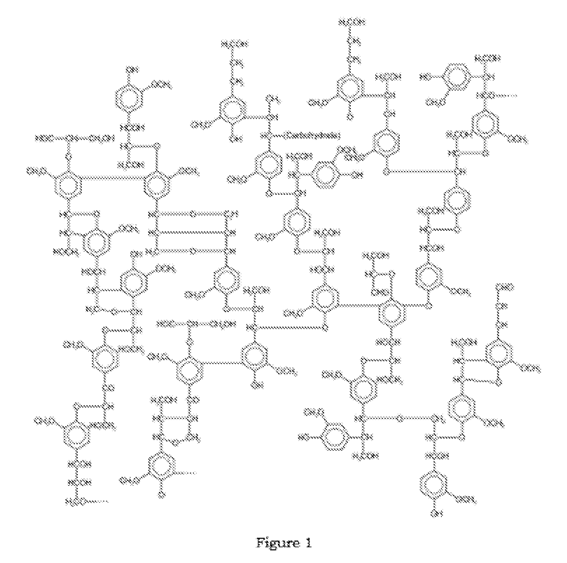

In the present application the term “lignin” means a polymer comprising coumaryl alcohol, coniferyl alcohol and sinapyl alcohol monomers. FIG. 1 discloses a schematic picture of lignin.

In the present application the term “carrier liquid” means an inert hydrocarbon liquid suitable for a hydrotreater or a catalytic cracker (cat cracker) or slurry cracking a liquid and may be selected from fatty acids or mixture of fatty acids, esterified fatty acids, triglyceride, rosin acid, crude oil, mineral oil, tall oil, creosote oil, tar oil, bunker fuel and hydrocarbon oils or mixtures thereof.

In the present invention the term “oil” means a nonpolar chemical substance that is a viscous liquid at ambient temperature and is both hydrophobic and lipophilic.

In the present application the terms “red liquor” and “brown liquor” denote the same liquor.

In the present invention the wording “aqueous solution” also includes water and water of any purity.

Kraft Lignin

The lignin of the present invention is Kraft lignin which means that is obtained from a spent cooking liquor from a Kraft process. The spent cooking liquor may be black liquor.

Black liquor comprises four main groups of organic substances, around 30-45 weight % ligneous material, 25-35 weight % saccharine acids, about 10 weight % formic and acetic acid, 3-5 weight % extractives, about 1 weight % methanol, and many inorganic elements and sulphur. The inorganic elements may be sodium, calcium, magnesium, iron, vanadium and other metals. Some of these elements come from the cooking chemicals and some from the wood. The exact composition of the liquor varies and depends on the cooking conditions in the production process and the feedstock. Kraft lignin is usually obtained from black liquor and therefore always contains high amounts of inorganic substances such as metals and salts.

Composition of Ultrapure Kraft Lignin

High value products from lignin such as carbon fibers as well as process' for preparing fuel from lignin demand high purity of the lignin raw material. Therefore the present inventors have developed the lignin according to the present invention is of very high purity.

The purity of the present composition is not dependent on the molecular weight of the lignin. Instead the present inventors have developed a composition in which Kraft lignin of any molecular weight can be used. Still depending on the Kraft process and any post treatment (precipitation, filtration etc) the weight average molecular weight (M_{w}) of the Kraft lignin in the present composition may be 10,000 g/mol or less, or 7,000 g/mol or less, or 5,000 g/mol or less, or 4,500 g/mol or less, or 3,500 g/mol or less, or 2,500 g/mol or less. In one embodiment the M_{w} is in the range of 500-4,500 g/mol. In one embodiment the M_{w} is in the range of 500-2,200 g/mol.

Molecular weight in the present application is determined using GPC (Gel Permeation Chromatography) operated at 20° C. and at flow rate of 1 ml/min using THF as solvent. Polystyrene Standard RedayCal Set M(p) 250-70000 (16 standards) (Sigma product no: 76552). The columns are Styragel THF (pre-column), Styragel HR 3 THF (7.8×300 mm), Styragel HR 1 THF (7.8×300 mm), Styragel HR 0.5 THF (7.8×300 mm) all from Waters.

The composition according to the present invention may contain almost only lignin besides some small contents of solvent residues. The composition may contain an aqueous solution and the amount of lignin in the composition depends on the number of drying steps and which drying steps have been used. The composition may be a suspension or slurry of Kraft lignin in an aqueous solution and where the amount of lignin is from 1 wt % up to nearly 100 wt %. In many applications and processes the amount of water or solvent should be as low as possible and therefore the content of ultra-pure Kraft lignin in the composition may be at least 80 wt %, preferably at least 90 wt %, preferably at least 95 wt %, preferably at least 99 wt %.

The amount of metals should be as low as possible since the metal may influence the properties of the final product or damage catalysts for example during the refining process. The total metal content of the composition should be less than 500 ppm, preferably less than 400 ppm, or less than 300 ppm, or less than 200 ppm, or less than 150 ppm.

Depending on the chemicals used in the Kraft process and depending on the wood source different inorganic and metal compounds may be found in the composition and in various amounts. Some common metals are aluminum, calcium, cadmium, chromium, copper, iron, magnesium, potassium, manganese, molybdenum, silver, sodium, nickel, lead, vanadium and zinc. Some common inorganic compounds are phosphor and sulphur.

In the present composition the sodium content is surprisingly low and this is independent on the molecular weight of the lignin. The sodium content is less than 200 ppm usually lower than 150 ppm by weight. In one embodiment the sodium content is 100 ppm or less, 80 ppm or less, or 60 ppm or less, or 50 ppm or less, or 40 ppm or less, or 30 ppm or less. In another embodiment the sodium content is 10-50 ppm.

The calcium content of the present composition is preferably less than 200 ppm, or less than 150 ppm, or less than 100 ppm, or less than 80 ppm, or less than 50 ppm. The potassium content is preferably less than 30 ppm, or less than 20 ppm, or less than 10 ppm.

The content of transition metals in the present composition may be less than 300 ppm, or less than 200 ppm, or less than 150 ppm, or less than 100 ppm, or less than 80 ppm. The chromium content is preferably less than 30 ppm, or less than 20 ppm, or less than 10 ppm, or less than 5 ppm. The aluminum content is preferably less than 40 ppm, or less than 30 ppm, or less than 20 ppm, or less than 10 ppm. The iron content is preferably less than 60 ppm, or less than 40 ppm, or less than 20 ppm, less than 10 ppm. The magnesium content is preferably less than 60 ppm, or less than 40 ppm, or less than 20 ppm, less than 10 ppm. The manganese content is preferably less than 60 ppm, or less than 40 ppm, or less than 20 ppm, less than 10 ppm. The nickel content is preferably less than 50 ppm, or less than 30 ppm, or less than 10 ppm, less than 5 ppm. The vanadium content is preferably less than 150 ppm, or less than 100 ppm, or less than 80 ppm, less than 60 ppm, or less than 40 ppm. The cupper content is preferably less than 60 ppm, or less than 40 ppm, or less than 20 ppm, less than 10 ppm. The zinc content is preferably less than 80 ppm, or less than 60 ppm, or less than 40 ppm, less than 30 ppm. The phosphor content is preferably less than 50 ppm, or less than 30 ppm, or less than 20 ppm, less than 10 ppm.

The cadmium content is preferably less than 15 ppm, or less than 10 ppm, or less than 5 ppm. The lead content is preferably less than 15 ppm, or less than 10 ppm, or less than 5 ppm.

In a refinery process for making fuel such as in a hydrotreater sulphur may be a wanted substance since it activates the catalysts such as NiMo or CoMO catalysts to prepare sulfide catalysts. In the present composition the sulphur content may be 10,000 ppm or higher, or 12,000 ppm or higher, or 15,000 ppm or higher, or 20,000 ppm or higher. In one embodiment the sulphur content is 10,000-20,000 ppm.

A carrier liquid may be added to the composition in order to make it more suitable for refinery processes. In one embodiment the carrier liquid is a fatty acid or a mixture of fatty acids. In another embodiment the carrier liquid is esterified fatty acids such as FAME (fatty acid methyl ester). The fatty acid used in the present invention (as fatty acid or as esterified fatty acid) may be a C4 or longer fatty acid, or C8 or longer fatty acid, or a C14 or longer fatty acid. In one embodiment the fatty acid or the mixture of the fatty acids or the esterified fatty acid comprises unsaturated fatty acids, preferably at a concentration of more than 25 wt %, or more than 50 wt %. In one embodiment the carrier liquid is a tall oil. In one embodiment the carrier liquid is a crude oil. In another embodiment the carrier liquid is a hydrocarbon oil or a mineral oil. In yet another embodiment the carrier liquid is a mixture of a fatty acid and crude oil, or a hydrocarbon oil or a mineral oil. The ratio in said mixture may be 5-90 wt % (of the total weight of the carrier liquid) fatty acid or esterified fatty acid and 10-95 wt % of hydrocarbon oil or mineral oil, for example 10-40 wt % fatty acid or esterified fatty acid and 60-90 wt % of hydrocarbon oil or mineral oil.

When the carrier liquid is or comprises a hydrocarbon oil the oil needs to be in liquid phase below 80° C. and preferably have boiling points of 177-371° C. These hydrocarbon oils include different types of or gas oils and likewise e.g. light cycle oil (LCO), Full Range Straight Run Middle Distillates, Hydrotreated, Middle Distillate, Light Catalytic Cracked Distillate, distillates Naphtha full-range straight-run, hydrodesulfurized full-range, solvent-dewaxed straight-range, straight-run middle sulfenylated, Naphtha clay-treated full-range straight run, distillates full-range atm, distillates hydrotreated full-range, straight-run light, distillates heavy straight-run, distillates (oil sand), straight-run middle-run, Naphtha (shale oil), hydrocracked, full-range straight run (example of but not restricted to CAS nr: 68476-30-2, 68814-87-9, 64742-46-7, 64741-59-9, 64741-44-2, 64741-42-0, 101316-57-8, 101316-58-9, 91722-55-3, 91995-58-3, 68527-21-9, 128683-26-1, 91995-46-9, 68410-05-9, 68915-96-8, 128683-27-2, 195459-19-9).

The composition may comprise 10-99 weight % of carrier liquid of the total weight of the composition, such as 20 weight % or more, or 40 weight % or more, or 60 weight % or more, or 80 weight % or more, or 99 weight % or less, or 85 weight % or less, or 65 weight % or less. In one embodiment the amount of carrier liquid is 60-90 weight % such as 65-85 weight %. The amount of lignin in the composition with a carrier liquid may be 1 weight % or more, or 2 weight % or more, or 4 weight % or more, or 5 weight % or more, or 7 weight % or more, or 10 weight % or more, or 12 weight % or more, or 15 weight % or more, or 20 weight % or more, or 25 weight % or more, or 30 weight % or more, or 40 weight % or more, or 50 weight % or more, or 60 weight % or more, or 70 weight % or more, or 75 weight % or more. In one embodiment the lignin content is 10-40 weight % such as 15-35 weight %. A composition of lignin and a carrier liquid may be in the form of a dispersion or slurry.

The present composition may further comprise small amounts of cellulose and hemi cellulose.

Preparation of the Composition

The composition according to the present invention may be prepared in several steps where the first step is to provide an aqueous mixture of Kraft lignin. The mixture may be a solution or a suspension and may be a spent cooking liquor such as black liquor. To the mixture is then carbon dioxide added in order to precipitate the lignin in the mixture. The lignin is isolated from the mixture using any suitable technique such as centrifugation, suction filtration, filter press, or combination thereof. After the isolation the isolated Kraft lignin contains small amounts of water and salts of metals and inorganic compounds. The aqueous solution of Kraft lignin of step a may be obtained by
i. precipitating the Kraft lignin from a spent cooking liquor such as black liquor by adding carbon dioxide to the cooking liquor,
ii. isolating at least a part of the precipitated Kraft lignin,
iii. optionally rinsing the isolated lignin using an aqueous solution; and
iv. optionally drying the isolated lignin.

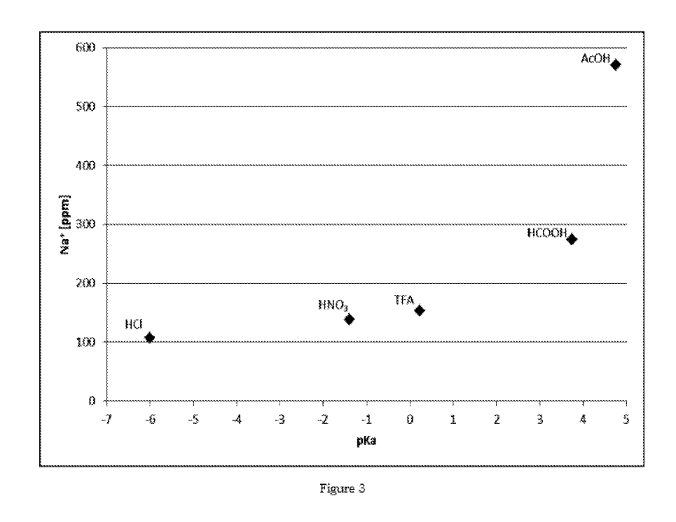

In a second step a diluted acid is added to the isolated lignin. The acid may sulfuric acid, hydrochloric acid, formic acid or acetic acid for example. As can be seen in FIG. 3 there is an unexpected drop in sodium content when using acids having a pKa lower than acetic acid. In one embodiment the acid has a pKa lower than 4.75, or lower than 4.0, or lower than 3.5, or lower than 3. The amount of acid added is preferably at least so that the amount of protons adds up to the total cationic charges of the metallic and inorganic compounds of the isolated lignin, or the amount is so that the amount of protons adds up to at least 1.5 of the total cationic charges, or at least 2 times the total cationic charges. The amount of water used to dilute the acid may be from 0.2 to 10 times the amount of lignin for example 2 times or more, or 3 times or more, or 9 times or less, or 8 times or less such as 0.5-8 times, or 1-7 times, or 1-3 times. The acid treated lignin may then be isolated using any suitable technique such as centrifugation, suction filtration, filter press, or combination thereof. The acid treated isolated Kraft lignin contains small amounts of water and a reduced amount of salts of metals and inorganic compounds. In order to even further lower the amount of metals in the isolated Kraft lignin the second step of adding a diluted acid and isolation may be repeated. In one embodiment the second step is repeated once or more, or twice or more, or three times or more, or four times or more. As seen in the examples the removal of metals is more efficient if the total amount of acid is divided into smaller portions and the step is repeated. Between each step as much water as possible is preferably removed.

In a third step the acid treated isolated Kraft lignin is washed with an aqueous solution in two or more steps or in one or more steps using ultrafiltration, membrane filtration, cross flow filtration, particle filtration or soaxhlet extraction. When doing the acid treatment in one step using ultrafiltration, membrane filtration, cross flow filtration, particle filtration or soaxhlet extraction, the acid is then added to the isolated Kraft lignin and the salts are then continuously or discontinuously removed using any of the mentioned techniques. The washing is done by adding the aqueous solution to the isolated lignin and optionally mixing the obtained solution before isolating the lignin. The step is repeated at least once but preferably two or more times, or three or more times, or four or more times. The washing may be done until an essentially neutral pH is obtained for example a pH of 7.0-7.4. Between each step as much water as possible is preferably removed. The present inventors found that a much higher purity of the Kraft lignin was obtained if an amount of aqueous solution was divided up into several steps in the washing procedure than to use the full amount in one step. The isolation of the lignin may be done using any suitable technique such as centrifugation, suction filtration, filter press, or combination thereof. The obtained isolated lignin may be dried for example in an oven at an elevated temperature such as at 50° C. or higher.

The aqueous solution used for washing may be water or a diluted acid preferably having a pKa lower than 4.75 or lower than 4.0 such as sulfuric acid, hydrochloric acid or formic acid. In one embodiment the acid is diluted 5-15 times with water such as 8-10 times. In one embodiment the diluted acid used during washing is 0.01M or lower sulfuric acid, or 0.001M or lower sulfuric acid. In one embodiment at least one of the washing steps is done using water.

The first step may be replaced by other methods for isolating lignin from a spent cooking liquor such as filtration, cross flow filtration, membrane filtration, ultrafiltration or acid precipitation and isolation or Lignoboost®.

The third step may be replaced by other methods for washing particle suspensions such as particle filtration, ultra-filtration, microfiltration, membrane filtration, soxhlet extraction.

An advantage of the present invention is that there is no need to heat during the method. All the steps above (besides when drying is done at elevated temperature) may be performed at room temperature, 20-25° C. However each of the steps a) to g) may be performed at an elevated temperature such as at 30° C. or higher, or 50° C. or higher, or 70° C. or higher but preferably at 90° C. or lower, or 80° C. or lower, or 75° C. or lower, or 65° C. or lower but preferably above 0° C., or above 10° C. In one embodiment step b is performed at a temperature of 80° C. or lower, or 75° C. or lower, or 65° C. or lower. In another embodiment step e is performed at a temperature of 80° C. or lower, or 75° C. or lower, or 65° C. or lower. The average temperature during the method may be room temperature, 20-25° C., but it may also be at 90° C. or lower, or 80° C. or lower, or 75° C. or lower, or 65° C. or lower but preferably above 0° C., or above 10° C.

An advantage of the present method is the high yield of ultra-pure Kraft lignin. The method according to the present invention shows a yield of at least 50 wt %, or at least 60 wt %, or at least 70 wt %, or at least 80 wt %, or at least 90 wt %, or at least 95 wt %.

The present inventors have performed large number of experiments and below are some concluding remarks on the results.

Comparing Example CD1 and CD2: The positively charged metal cations cannot be washed away from the lignin with only water. This is because the lignin itself functions as the negatively charged counter ion. To circumvent this problem an acid is added to exchange the metal cations with protons from the acid. When only water is used the sodium level drops to 719 ppm but with the use of H2SO4 the Na+ level drops to 192 ppm.

Comparing Example CD3 and CD4: How the washing is preformed plays a significant role to the levels of metal ions in the final sample. In CD3 the washing is performed in one step with the use of 40 ml of water while in CD4 the same volume is used, however the washing is preformed four times with 10 ml. In this way the sodium level can be reduced from 277 (CD3) to 187 ppm (CD4).

Comparing Example CD5 and CD6: Instead of washing the lignin one time with acid (0.05M) followed by three times with water, the lignin can be washed four times using the same total amount of acid but diluted with the water from the subsequent washing steps, giving an acid concentration of 0.0125M. This is to ensure the availability of protons during the whole washing process. In this way the sodium ion level can be reduced from 209 (CD5) to 192 ppm (CD6).

Comparing Example CD7-CD11: To avoid using a huge excess of acid the pKa of the acid should be low. The acids investigated with their corresponding pKa's were; hydrochloric acid (HCl, −6), nitric acid (HNO₃, −1.4), trifluoroacetic acid (TFA, 0.23), formic acid (HCOOH, 3.75), and acetic acid (AcOH, 4.75). The acid used should preferably have a pKa lower than acetic acid, i.e. lower than 4.75, in order to obtain an ultra-pure lignin.

Some acids that could be used with their respective pKa are:

H₂SO₄ (−3.0, 1.99), HF (3.17), HCl (−8), HBr (−9), HClO₄ (−10), H₂SO₃ (1.9, 7.21), H₃PO₄ (2.12, 7.21, 12.32), HNO₃ (−1.3), HNO₂ (3.29), H₂CrO₄ (−0.98, 6.50), CH₃SO₃H (−2.6), CF₃SO₃H (−14), NO₂CH₂COOH (1.68), FCH₂COOH (2.66), ClCH₂COOH (2.86), BrCH₂COOH (2.86), ICH₂COOH (3.12), Cl₂CHCOOH (1.29), Cl₃CCOOH (0.65), F₃CCOOH (−0.25), HCOOH (3.77), HOCOOH (3.6, 10.3), C₆H5COOH (4.2), o-O₂NC₆H₄COOH (2.17), m-O₂NC₆H₄COOH (2.45), p-O₂NC₆H₄COOH (3.44), o-ClC₆H₄COOH (2.94), C₆H₅SO₂H (2.1), C₆H5SO₃H (−2.6), oxalic acid (1.2), lactic acid (3.9), malic acid (3.4), citric acid (3.1), CH3C6H4SO3H (−2.8), H₂NCH₂PO₃H₂ (0.4).

A1: The yield of the washing process is very high when starting from a acid precipitated lignin. The yield can be as high as 98%.

Applications

The ultra-pure lignin according to the present invention may be used for example in a refinery process for preparing fuels such as petrol or diesel, or fine chemicals. The fuel may be prepared by treating the composition in a hydrotreater, hydro cracker or a slurry cracker using well known techniques.

The composition may also be used in materials or composites together with another polymer, a second polymer. This second polymer may be selected from polyolefin, polyester, polyamide, polynitrile or a polycarbonate.

The second polymer may be any suitable natural or synthetic polymer. In one embodiment the polymer is a polyolefin such as polyethylene or polypropylene. In another embodiment the second polymer is a polyester such as polyethylene terephthalate, polylactic acid or polyglycolic acid. In another embodiment the second polymer is a polynitrile such as polyacrylonitrile (PAN). In another embodiment the second polymer is a polycarbonate.

The amount of first polymer in the material may be 1-99 wt %, such as 3 wt % or more, or 5 wt % or more, or 10 wt % or more, or 15 wt % or more, or 20 wt % or more, or 25 wt % or more, or 30 wt or more, or 35 wt % or more, or 40 wt % or more, or 45 wt % or more, or 50 wt % or more, or 90 wt % or less, or 85 wt % or less, or 80 wt % or less, or 75 wt % or less, or 70 wt % or less, or 65 wt % or less, or 60 wt % or less.

The amount of modified lignin in the material may be 1-99 wt %, such as 3 wt % or more, or 5 wt % or more, or 10 wt % or more, or 15 wt % or more, or 20 wt % or more, or 25 wt % or more, or 30 wt or more, or 35 wt % or more, or 40 wt % or more, or 45 wt % or more, or 50 wt % or more, or 90 wt % or less, or 85 wt % or less, or 80 wt % or less, or 75 wt % or less, or 70 wt % or less, or 65 wt % or less, or 60 wt % or less.

### EXAMPLES

In some of the examples below the following lignin types have been used. The lignin types A1-A4 are derived from different pulping mills.

Lignin type A1: acid precipitated lignin from black liquor

Lignin type A2: acid precipitated lignin from black liquor

Lignin type A3: acid precipitated lignin from black liquor

Lignin type B: carbon dioxide precipitated black liquor

Lignin type C: dried ultrafiltrated black liquor

Lignin type D: dried black liquor attained from deciduous trees.

Lignin type A4: acid precipitated lignin from black liquor

Acid precipitated means that lignin has been precipitated using CO₂ and sulfuric acid in accordance with Lignoboost® technique.

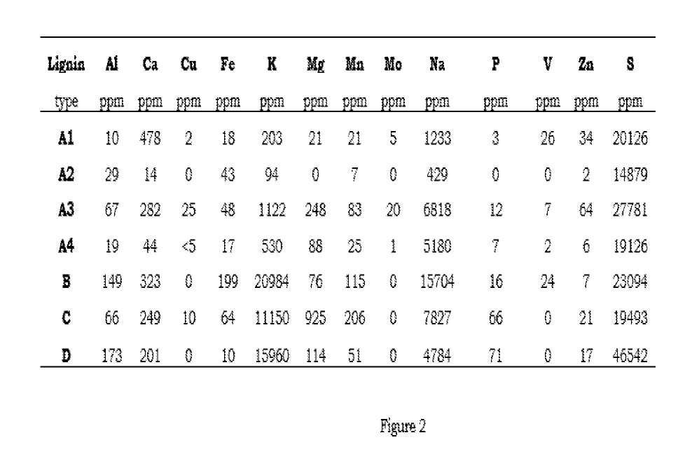

In FIG. 2 the metal contents of the different lignin types are disclosed.

Unless otherwise stated the examples below are performed at room temperature. When washing is done using a Büchner funnel in the examples below the washing is done in several steps until the given total volume has been used or until essentially neutral pH has been reached in the washing water.

### Example 1

Lignin type A1 (2 kg) is stirred into H₂SO₄ (30 ml conc. H₂SO₄ in 3 L water, pH ˜0.74). The mixture was shaken overnight at room temperature. The mixture was poured into a büchner funnel and washed with deionized water (total volume 6 L). Lignin sample was dried in oven at 50 degrees ° C. and metal content was analysed by ICP-AES.

The obtained lignin composition contained around 180 ppm metals and the major compounds were (ppm):

| Al | Ca | Cu | Fe | K | Mg | Mn | Mo | Na | P | V | Zn | S |
|---|---|---|---|---|---|---|---|---|---|---|---|---|
| 8 | 43 | 1 | 11 | <5 | 9 | 10 | 6 | 30 | 5 | 34 | 21 | 22557 |

### Example 2

Lignin type A2 (5 g) was added to acetic acid (20 ml) and heated under stirring (20 min). Deionized water (20 ml) was added after the reaction mixture had cooled forming a precipitate. The water/acetic acid phase was removed from the precipitate. The remaining percipitate was washed with deionized water until the washing water had a neutral pH. Lignin sample was dried in oven at 50 degrees C. and metal content was analysed by ICP-AES.

The obtained lignin composition contained around 60 ppm metals and the major compounds were (ppm):

| Al | Ca | Cu | Fe | K | Mg | Mn | Mo | Na | P | V | Zn | S |
|---|---|---|---|---|---|---|---|---|---|---|---|---|
| 18 | 0 | <5 | 25 | <5 | <5 | <1 | <5 | 9 | <5 | <5 | <1 | 13522 |

### Example 3

Lignin type B (5 g) was mixed with deionized water (20 ml). H₂SO₄ (0.8 ml, conc.) was added. Water was added until total volume was 40 ml. The mixture was stirred overnight. The mixture was poured into a büchner funnel and washed with deionized water until the washing water had a neutral pH. Sample was dried in oven at 50 degrees C. and metal content was analysed by ICP-AES.

The obtained composition contained around 7700 ppm metals and the major compounds were (ppm):

| Al | Ca | Cu | Fe | K | Mg | Mn | Mo | Na | P | V | Zn | S |
|---|---|---|---|---|---|---|---|---|---|---|---|---|
| 52 | 87 | <5 | 92 | 1976 | 12 | 22 | <5 | 5469 | <5 | 6 | 2 | 25094 |

### Example 4

Lignin type B (5 g) was mixed with deionized water (20 ml). H₂SO₄ (0.1 ml, conc.) was added. Water was added until total volume was 40 ml. The mixture was stirred overnight. The mixture was poured into a büchner funnel and washed with deionized water until the washing water had a neutral pH. Sample was dried in oven at 50 degrees C. and metal content was analysed by ICP-AES.

The obtained composition contained around 90 ppm metals and the major compounds were (ppm):

| Al | Ca | Cu | Fe | K | Mg | Mn | Mo | Na | P | V | Zn | S |
|---|---|---|---|---|---|---|---|---|---|---|---|---|
| 25 | 6 | <5 | 38 | <5 | <5 | 4 | <5 | 16 | <5 | <5 | 1 | 14401 |

### Example 5

Lignin type C (5 g) was mixed with deionized water (20 ml). H₂SO₄ (5.5 ml, conc.) was added. Water was added until total volume was 40 ml. The mixture was stirred overnight. The mixture was poured into a büchner funnel and washed with deionized water until the washing water had a neutral pH. Sample was dried in oven at 50 degrees C. and metal content was analysed by ICP-AES.

The obtained composition contained around 300 ppm metals and the major compounds were (ppm):

| Al | Ca | Cu | Fe | K | Mg | Mn | Mo | Na | P | V | Zn | S |
|---|---|---|---|---|---|---|---|---|---|---|---|---|
| 3 | 11 | 12 | 26 | 30 | 20 | 6 | <5 | 191 | <5 | <5 | 3 | 18293 |

### Example 7

Lignin type A2 (5 g) was mixed with deionized water until total volume was 40 ml. The mixture was stirred overnight. The mixture was poured into a büchner funnel and washed with deionized water until the washing water had a neutral pH. Sample was dried in oven at 50 degrees C. and metal content was analysed by ICP-AES.

The obtained composition contained around 160 ppm metals and the major compounds were (ppm):

| Al | Ca | Cu | Fe | K | Mg | Mn | Mo | Na | P | V | Zn | S |
|---|---|---|---|---|---|---|---|---|---|---|---|---|
| 27 | 8 | <5 | 41 | 17 | <5 | 5 | <5 | 56 | <5 | <5 | 2 | 14086 |

### Example 8

Lignin type A2 (5 g) was mixed with deionized water (20 ml). H₂SO₄ (0.05 ml, conc.) was added. Water was added until total volume was 40 ml. The mixture was stirred overnight. The mixture was poured into a büchner funnel and washed with deionized water until the washing water had a neutral pH. Sample was dried in oven at 50 degrees C. and metal content was analysed by ICP-AES.

The obtained composition contained around 100 ppm metals and the major compounds were (ppm):

| Al | Ca | Cu | Fe | K | Mg | Mn | Mo | Na | P | V | Zn | S |
|---|---|---|---|---|---|---|---|---|---|---|---|---|
| 27 | 7 | <5 | 40 | <5 | <5 | 5 | <5 | 24 | <5 | <5 | 1 | 14017 |

### Example 9

Lignin type A2 (5 g) was mixed with deionized water (20 ml). H₂SO₄ (0.2 ml, conc.) was added. Water was added until total volume was 40 ml. The mixture was stirred overnight. The mixture was poured into a büchner funnel and washed with deionized water until the washing water had a neutral pH. Sample was dried in oven at 50 degrees C. and metal content was analysed by ICP-AES.

The obtained composition contained around 100 ppm metals and the major compounds were (ppm):

| Al | Ca | Cu | Fe | K | Mg | Mn | Mo | Na | P | V | Zn | S |
|---|---|---|---|---|---|---|---|---|---|---|---|---|
| 26 | 6 | <5 | 44 | <5 | <5 | 5 | <5 | 17 | <5 | <5 | 1 | 13048 |

### Example 10

Lignin type A2 (5 g) was mixed with deionized water (20 ml). H₂SO₄ (0.3 ml, conc.) was added. Water was added until total volume was 40 ml. The mixture was stirred overnight. The mixture was poured into a büchner funnel and washed with deionized water until the washing water had a neutral pH. Sample was dried in oven at 50 degrees C. and metal content was analysed by ICP-AES.

The obtained composition contained around 114 ppm metals and the major compounds were (ppm):

| Al | Ca | Cu | Fe | K | Mg | Mn | Mo | Na | P | V | Zn | S |
|---|---|---|---|---|---|---|---|---|---|---|---|---|
| 29 | 10 | <5 | 42 | <5 | <5 | 6 | <5 | 25 | <5 | <5 | 2 | 14426 |

### Example 11

Lignin type D (5 g) was mixed with deionized water (70 ml). H₂SO₄ (5.5 ml, conc.) was added. The mixture was stirred overnight. The mixture was poured into a büchner funnel and washed with deionized water until the washing water had a neutral pH. Sample was dried in oven at 50 degrees C. and metal content was analysed by ICP-AES.

The obtained composition contained around 268 ppm metals and the major compounds were (ppm):

| Al | Ca | Cu | Fe | K | Mg | Mn | Mo | Na | P | V | Zn | S |
|---|---|---|---|---|---|---|---|---|---|---|---|---|
| 13 | 10 | <5 | 7 | 15 | <5 | 1 | 8 | 213 | 12 | <5 | 1 | 58266 |

### Example 12

Lignin type (2.5 g) was mixed with deionized water (20 ml). Formic acid (5 ml) was added. The mixture was stirred 30 min. The mixture was poured into a büchner funnel and washed with deionized water until the washing water had a neutral pH. Sample was dried in oven at 50 degrees C. and metal content was analysed by ICP-AES.

The obtained composition contained around 165 ppm metals and the major compounds were (ppm):

| Al | Ca | Cu | Fe | K | Mg | Mn | Mo | Na | P | V | Zn | S |
|---|---|---|---|---|---|---|---|---|---|---|---|---|
| 26 | 7 | <5 | 40 | 12 | <5 | 5 | <5 | 72 | <5 | <5 | 1 | 14111 |

### Example 1A

Lignin type A2 (5 g) was mixed with H₂SO₄ (20 ml, 0.05M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES. The yield was 98.2% (4.91 g precipitate was retrieved after drying).

The obtained composition contained around 222 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 34 | 15 | <5 | 35 | <10 | 5 | 6 | <2 | 27 | 6 | 5 | <2 | 12255 |

### Example 1B

Lignin type A2 (5 g) was mixed with deionized water (20 ml) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 270 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 51 | <5 | <5 | 29 | 15 | 5 | 5 | 2 | 72 | 7 | 6 | <2 | 12074 |

### Example 3A

Lignin type A2 (5 g) was mixed with H₂SO₄ (20 ml, 0.05M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 193 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 31 | <5 | <5 | 31 | <10 | 5 | 6 | <2 | 13 | 7 | 5 | <2 | 11868 |

### Example 3B

Lignin type A2 (5 g) was mixed with H2SO4 (20 ml, 0.0125M) in a centrifuge tube and shaken overnight. Deionized water was added until total volume was 40 ml. The mixture was centrifuged at 3000 g for 3 min. The supernatant was decanted. The precipitate was washed three times by adding H2SO4 (20 ml, 0.0125M) and deionized water until total volume was 40 ml, shaking, centrifuging, and decanting. Sample was dried in oven at 50° C. and metal content was analyzed by ICP-AES

The obtained composition contained around 200 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 32 | <5 | <5 | 31 | <10 | 6 | 6 | 2 | 17 | 8 | 5 | <2 | 12324 |

### Example 4A

Lignin type A2 (5 g) was mixed with HCl (20 ml, 0.1M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 216 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 35 | <5 | <5 | 49 | <10 | 6 | 6 | 3 | 12 | 7 | 6 | <2 | 12483 |

### Example 4B

Lignin type A2 (5 g) was mixed with HNO3 (20 ml, 0.1M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 170 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 30 | <5 | <5 | 25 | <10 | 5 | 5 | 3 | <10 | 7 | 6 | <2 | 11668 |

### Example 4C

Lignin type A2 (5 g) was mixed with TFA (20 ml, 0.1M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 194 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 40 | <5 | <5 | 27 | <10 | 6 | 6 | <2 | <10 | 6 | 6 | <2 | 11974 |

### Example 4D

Lignin type A2 (5 g) was mixed with HCOOH (20 ml, 0.1M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 241 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 49 | 42 | <5 | 27 | <10 | 5 | 6 | 4 | 15 | <5 | 5 | <2 | 11838 |

### Example 4E

Lignin type A2 (5 g) was mixed with AcOH (20 ml, 0.1M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 252 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 39 | <5 | <5 | 30 | 13 | 6 | 6 | 2 | 67 | 7 | 5 | <2 | 11875 |

### Example 5A

Lignin type A2 (5 g) was mixed with H₂SO₄ (20 ml, 0.05M) and citric acid (50 mg) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 214 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 40 | <5 | <5 | 31 | <10 | 8 | 6 | 5 | 18 | 5 | 5 | <2 | 12084 |

### Example 5B

Lignin type A2 (5 g) was mixed with H₂SO₄ (20 ml, 0.05M) and citric acid (100 mg) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 191 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 37 | <5 | <5 | 30 | <10 | 6 | 6 | 3 | <10 | 11 | 5 | <2 | 11861 |

### Example 5C

Lignin type A2 (5 g) was mixed with H₂SO₄ (20 ml, 0.05M) and citric acid (500 mg) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 181 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 34 | <5 | <5 | 25 | <10 | 5 | 5 | 4 | <10 | <5 | 5 | <2 | 11949 |

### Example 5D

Lignin type A2 (5 g) was mixed with H₂SO₄ (20 ml, 0.05M) and citric acid (1000 mg) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 400 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 234 | <5 | <5 | 34 | <10 | 5 | 6 | 3 | 11 | 6 | 6 | <2 | 12113 |

### Example CD1

Lignin type A4 (5 g) was mixed with H₂SO₄ (20 ml, 0.05M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 517 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 35 | 54 | 1 | 25 | 10 | 112 | 38 | 1 | 192 | 10 | 2 | 3 | 14027 |

### Example CD2

Lignin type A4 (5 g) was mixed with deionized water (20 ml) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 1111 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 34 | 53 | 1 | 25 | 75 | 114 | 39 | 1 | 719 | 9 | 2 | 4 | 14052 |

### Example CD3

Lignin type A4 (5 g) was mixed with H₂SO₄ (20 ml, 0.05M) in a centrifuge tube and shaken overnight. Deionized water was added until total volume was 40 ml. The mixture was centrifuged at 3000 g for 3 min. The supernatant was decanted. The precipitate was washed once by adding deionized water (40 ml), shaking, centrifuging, and decanting. Sample was dried in oven at 50° C. and metal content was analyzed by ICP-AES.

The obtained composition contained around 603 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 33 | 47 | 1 | 27 | 15 | 113 | 39 | 1 | 277 | 10 | 2 | 3 | 14386 |

### Example CD4

Lignin type A4 (5 g) was mixed with H₂SO₄ (20 ml, 0.05M) in a centrifuge tube and shaken overnight. Deionized water was added until total volume was 40 ml. The mixture was centrifuged at 3000 g for 3 min. The supernatant was decanted. The precipitate was washed four times by adding deionized water (10 ml), shaking, centrifuging, and decanting. Sample was dried in oven at 50° C. and metal content was analyzed by ICP-AES.

The obtained composition contained around 486 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 31 | 43 | 1 | 25 | 9 | 103 | 36 | 1 | 187 | 11 | 2 | 3 | 13726 |

### Example CD5

Lignin type A4 (5 g) was mixed with H2SO4 (20 ml, 0.05M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 517 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 33 | 46 | 1 | 25 | 12 | 112 | 38 | 1 | 209 | 8 | 2 | 3 | 16577 |

### Example CD6

Lignin type A4 (5 g) was mixed with H2SO4 (20 ml, 0.0125M) in a centrifuge tube and shaken overnight. Deionized water was added until total volume was 40 ml. The mixture was centrifuged at 3000 g for 3 min. The supernatant was decanted. The precipitate was washed three times by adding H2SO4 (20 ml, 0.0125M) and deionized water until total volume was 40 ml, shaking, centrifuging, and decanting. Sample was dried in oven at 50° C. and metal content was analyzed by ICP-AES

The obtained composition contained around 497 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 32 | 44 | 1 | 24 | 11 | 109 | 38 | 1 | 192 | 11 | 2 | 3 | 14142 |

### Example CD7

Lignin type A4 (5 g) was mixed with HCl (20 ml, 0.1M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 398 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 32 | 44 | 1 | 23 | 3 | 105 | 36 | 1 | 107 | 10 | 2 | 3 | 14309 |

### Example CD8

Lignin type A4 (5 g) was mixed with HNO3 (20 ml, 0.1M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 448 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 32 | 45 | 1 | 25 | 6 | 111 | 38 | 1 | 138 | 10 | 2 | 3 | 14076 |

### Example CD9

Lignin type A4 (5 g) was mixed with TFA (20 ml, 0.1M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 471 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 35 | 46 | 7 | 25 | 7 | 110 | 38 | 1 | 153 | 11 | 2 | 4 | 13984 |

### Example CD 10

Lignin type A4 (5 g) was mixed with HCOOH (20 ml, 0.1M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 604 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 33 | 45 | 1 | 24 | 23 | 113 | 38 | 1 | 275 | 10 | 2 | 4 | 13946 |

### Example CD11

Lignin type A4 (5 g) was mixed with AcOH (20 ml, 0.1M) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 939 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 33 | 49 | 1 | 26 | 53 | 115 | 40 | 1 | 571 | 9 | 2 | 4 | 13708 |

### Example CD12

Lignin type A4 (5 g) was mixed with H₂SO₄ (20 ml, 0.05M) and citric acid (50 mg) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 507 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 32 | 46 | 1 | 25 | 8 | 114 | 39 | 1 | 193 | 10 | 2 | 3 | 13881 |

### Example CD13

Lignin type A4 (5 g) was mixed with H₂SO₄ (20 ml, 0.05M) and citric acid (100 mg) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 455 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 32 | 44 | 1 | 25 | 5 | 108 | 37 | 1 | 158 | 8 | 2 | 3 | 13859 |

### Example CD14

Lignin type A4 (5 g) was mixed with H₂SO₄ (20 ml, 0.05M) and citric acid (500 mg) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 437 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 32 | 45 | 1 | 25 | 4 | 111 | 38 | 1 | 133 | 10 | 2 | 3 | 13543 |

### Example CD 15

Lignin type A4 (5 g) was mixed with H₂SO₄ (20 ml, 0.05M) and citric acid (1000 mg) in a centrifuge tube and shaken overnight. Deionized water was added until total volume was 40 ml. The mixture was centrifuged at 3000 g for 3 min. The supernatant was decanted. The precipitate was washed three times by adding deionized water until total volume was 40 ml, shaking, centrifuging, and decanting. Sample was dried in oven at 50° C. and metal content was analyzed by ICP-AES.

The obtained composition contained around 482 ppm metals and the major elements were (ppm):

| Al | Ca | Cu | Fe | K | Mg | Mn | Mo | Na | P | V | Zn | S |
|---|---|---|---|---|---|---|---|---|---|---|---|---|
| 31 | 45 | 1 | 24 | 9 | 107 | 37 | 1 | 178 | 10 | 2 | 3 | 13229 |

### Example A

Lignin type D (5 g) was mixed with deionized water (70 ml).

Dry ice was added until approximate pH9.

The mixture was filtered on a büchner funnel.

The precipitate was resuspended in water and pH was adjusted to <4 with H₂SO₄ (1M).

Water was added to 40 ml and the suspension was centrifuged at 3000 g for 3 min.

The precipitate was washed with water until pH of washing water was neutral.

Sample was dried in oven at 50 degrees C.

The above example was also performed by adjusting the pH to <3 and <2 and <1 with H₂SO₄ (1M).

### Example B

Lignin type D (5 g) was mixed with deionized water (70 ml).

H2SO4 (1M) was added until pH <4.

The mixture was filtered on a büchner funnel.

The precipitate was resuspended in and the total volume adjusted to 40 ml and the suspension was centrifuged at 3000 g for 3 min.

The precipitate was washed with water until pH of washing water was neutral.

Sample was dried in oven at 50 degrees C.

The above example was also performed by adding H2SO4 (1M) until pH <3 and <2 and <1.

### Example C

Lignin type D (5 g) was mixed with deionized water (70 ml).

H2SO4 (1M) was added until pH <2.

The mixture was filtered on a büchner funnel.

The precipitate was resuspended in water and the total volume adjusted to 40 ml and the suspension was centrifuged at 3000 g for 3 min.

The precipitate was washed with H2SO4 (0.05M, 1×40 ml). Sample was dried in oven at 50 degrees C.

The above example was also performed by washing the precipitate 2, 3, 4, and 5 times with H2SO4 (0.5M, 40 ml).

1. A composition comprising Kraft lignin having a weight average molecular weight (M_{w}) of less than 5,000 g/mol and wherein the total metal content of the composition is less than 400 ppm by weight; wherein the sodium content is less than 100 ppm by weight and wherein the content of transition metals is less than 150 ppm by weight.

2. The composition according to claim 1 wherein the M_{w} of the lignin is less than 4,000 g/mol such as a M_{w} in the range of 500-2,200 g/mol.

3. The composition according to claim 1 or 2 wherein the sulphur content is higher than 10,000 ppm by weight.

4. The composition according to any one of claims 1 to 3 wherein the sodium content is 80 ppm or less, or 60 ppm or less, or 50 ppm or less, or 40 ppm or less.

5. The composition according to any one of claims 1 to 4 wherein the total metal content is less than 300 ppm, or less than 200 ppm.

6. The composition according to any one of claims 1 to 5 wherein the Kraft lignin has a weight average molecular weight (M_{w}) of less than 5,000 g/mol, wherein the total metal content is less than 200 ppm and wherein the sodium content is 50 ppm or less and wherein the content of transition metals is less than 100 ppm by weight.

7. The composition according to any one of the preceding claims wherein the potassium content is 100 ppm or less, 80 ppm or less, or 60 ppm or less, or 50 ppm or less, or 40 ppm or less.

8. The composition according to any one of the preceding claims wherein the calcium content is 100 ppm or less, 80 ppm or less, or 60 ppm or less, or 50 ppm or less, or 40 ppm or less.

9. The composition according to any one of the preceding claims wherein the composition is an aqueous composition and wherein the content of Kraft lignin is at least 80 wt %, preferably at least 90 wt %, preferably at least 95 wt %, preferably at least 99 wt %.

10. The composition according to any one of claims 1 to 8 wherein the composition comprises a carrier liquid such as fatty acids or mixture of fatty acids, esterified fatty acids, triglyceride, rosin acid, crude oil, mineral oil, tall oil, creosote oil, tar oil, bunker fuel and hydrocarbon oils or mixtures thereof

11. A method of preparing the aqueous composition according to any one of claims 1 to 9 comprising:
a. Providing an aqueous mixture of Kraft lignin;
b. Adding an aqueous solution of acid to the mixture of Kraft lignin wherein the acid has a pKa lower than 4.75, preferably lower than 4.0;
c. Letting the Kraft lignin precipitate;
d. Isolating at least a part of the precipitated lignin; and
e. Adding an aqueous solution to the isolated lignin in order to wash the lignin;
f. Isolating the washed lignin; and
g. Repeating step e and f at least once.

12. The method according to claim 10 wherein the aqueous solution of Kraft lignin of step a is obtained by
i. precipitating the Kraft lignin from a spent cooking liquor such as black liquor by adding carbon dioxide to the cooking liquor,
ii. isolating at least a part of the precipitated Kraft lignin,
iii. optionally rinsing the isolated lignin using an aqueous solution; and
iv. optionally drying the isolated lignin.

13. The method according to claim 10 or 11 wherein the amount of acid added is at least so that the amount of protons added adds up to the total cationic charges of the metallic and inorganic compounds of the isolated lignin

14. The method according to any one of claims 10 to 12 wherein the step e and f is repeated at least two times, or at least three times, or at least four times.

15. The method according to any one of claims 10 to 13 wherein the steps b to d are repeated at least once, or at least twice, or at least three times, or at least four times.

16. The method according to any one of claims 10 to 14 wherein steps a to g are performed at a temperature of 80° C. or lower, or 75° C. or lower, or 65° C. or lower.

17. Use of the composition according to any one of claims 1 to 10 for preparing fuel.

18. Use of the composition according to any one of claims 1 to 10 in a hydrotreater and/or in a catalytic cracker or in a slurry cracker.

19. A fuel obtained from the composition according to any one of claims 1 to 10 by treating the composition in a hydrotreater and/or a catalytic cracker or a slurry cracker.

20. A composite comprising the lignin composition according to any one of claims 1 to 9 and a second polymer wherein the second polymer may be selected from polyolefin, polyester, polyamide, polynitrile or a polycarbonate.

21. The composition according to claim 20 wherein the lignin content is 1-99 wt %, such as 3 wt % or more, or 5 wt % or more, or 10 wt % or more, or 15 wt % or more, or 20 wt % or more, or 25 wt % or more, or 30 wt or more, or 35 wt % or more, or 40 wt % or more, or 45 wt % or more, or 50 wt % or more, or 90 wt % or less, or 85 wt % or less, or 80 wt % or less, or 75 wt % or less, or 70 wt % or less, or 65 wt % or less, or 60 wt % or less.
